(19) United States
(12) Patent Application Publication
(10) Pub. No.: US 2017/0201596 A1
(43) Pub. Date: Jul. 13, 2017

(54) ACHIEVING BALANCED IN-NETWORK CONTENT CACHING FRESHNESS

(71) Applicant: Convida Wireless, LLC, Wilmington, DE (US)

(72) Inventors: Vassilios VASSILAKIS, Surrey (GB); Ning WANG, Surrey (GB); Lijun DONG, San Diego, CA (US); Chonggang WANG, Princeton, NJ (US)

(21) Appl. No.: 15/320,896

(22) PCT Filed: Jun. 26, 2015
(86) PCT No.: PCT/US2015/038059

§ 371 Date: Dec. 21, 2016

(30) Foreign Application Priority Data
Jun. 27, 2014 (GR) 20140100358

(51) Int. Cl. H04L 29/08

(52) U.S. Cl. CPC H04L 67/2842

(57) ABSTRACT

The present application describes a method for caching content at a router. The method includes a step of receiving a content request from a requester along a path in a network. In addition, there is a step for determining and sending Local Cache Space (LCS) information along the path to a source. Moreover, there is a step for receiving current Aggregated Caching Space (ACS) information along the path from the source. Further, there is a step of determining a Caching Space Ratio (CSR) for the content request based upon the LCS information and the final ACS information. The present application is also directed to a router in a network. The router includes a non-transitory memory including LCS for saving content chunks for requested content. The router also includes a process operably coupled to the memory that is configured to execute one or more steps disclosed above.

### CROSS-REFERENCE TO RELATED APPLICATIONS

This application claims priority to Greek Patent Application No. 20140100358, filed Jun. 27, 2014, the disclosure of which is incorporated herein by reference in its entirety.

### BACKGROUND

In the last decade, in-network content caching has received significant attention in the Information-Oriented Networking (ION) community. In particular, caching named content in the network allows for such content to be more easily sent to subsequent users. In-network content caching also reduces content access delay and content transmission delay. This may be attributed to the reduced distance between the content source and the receiver. Another benefit of in-network content caching may also be realized in Internet Service Provider (ISP) networks' given the overall reduction of traffic.

Generally, in-network content caching is performed in an opportunistic manner. That is, content objects may be cached at routers located along the content delivery path. Each router may therefore have different opportunities to cache content chunks depending on its location within the network. Routers with a high degree of centrality—located in a large number of content delivery paths—need to replace cached content chunks at a much faster rate than remote, e.g., idle, routers—lower dynamic in content chunk caching and replacement. As such, the caching freshness, e.g., lifetime, of these routers may be very different for correlated content chunks of a content item.

Moreover, the limited physical caching space of a router requires it to locally replace its most obsolete content chunks once the caching space has been fully utilized. However, these routers in a delivery path are likely not synchronized with each other for caching freshness of correlated content chunks for a particular content item. As such, content chunks having a similar degree of popularity, such as for example, belonging to a video file, may be cached or replaced at different rates/times/speed according to their location network location.

Ultimately, the key issue is that each router only sees its own local popularity on chunks passing through. Depending on the location of these routers, a locally “obsolete” chunk at a busy router having a high replacement rate can certainly be very popular network wide. On the other hand, a locally “popular” chunk at an idle router with a low replacement rate is capable of staying in a cache for a long time. However, it may not be very popular in comparison to all of the chunks injected into the network.

### SUMMARY

This summary is provided to introduce a selection of concepts in a simplified form that are further described below in the Detailed Description of the Drawings. This Summary is not intended to limit the scope of the claimed subject matter. The foregoing needs are met, to a great extent, by the present application directed to a method and apparatus for achieving balanced in-network content caching freshness.

One aspect of the application is directed to a method for caching content at a router. The method includes a step of receiving a content request from a requester along a path in a network. In addition, there includes a step for sending Local Cache Space (LCS) information along the path to a source. Moreover, there is a step for receiving Aggregated Caching Space (ACS) information along the path from the source. Further, there is a step of determining a Caching Space Ratio (CSR) for the content request based upon the LCS information. According to one embodiment, the method further includes the steps of receiving content chunks based upon the content request from the source, and caching a subset of the received content chunks according to the CSR along the path. According to another embodiment, the content request is received along two or more paths in the network, and the LCS information is sent along the two or more paths in the network. In a further embodiment, the ACS information is received along each of the two or more paths.

Another aspect of the application is directed to a router in a network. The router includes a non-transitory memory including local cache space for saving content chunks related to requested content. The router also includes a process operably coupled to the memory. The processor is configured to execute the instructions of: (i) receiving a content request from a requester along a path in a network; (ii) sending LCS information along the path to a source; and (iii) receiving ACS information along the path from the source. In one embodiment, the processor of the router is further configured to determine a CSR for the content request based upon the LCS information.

There has thus been outlined, rather broadly, certain embodiments of the invention in order that the detailed description thereof may be better understood, and in order that the present contribution to the art may be better appreciated.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1A illustrates a system diagram of an example machine-to-machine (M2M), Internet of Things (IoT), or Web of Things (WoT) communication system in which one or more disclosed embodiments may be implemented according to the present application.

FIG. 1B illustrates a system diagram of an example architecture that may be used within the M2M/IoT/WoT communications system illustrated in FIG. 1A according to the present application.

FIG. 1C illustrates a system diagram of an example M2M/IoT/WoT terminal or gateway device that may be used within the communications system illustrated in FIG. 1A according to the present application.

FIG. 1D is a block diagram of an example computing system in which aspects of the communication system of FIG. 1A and the context-aware content publication and resolution concepts described herein may be embodied according to the present application.

FIG. 2A illustrates an embodiment of a oneM2M architecture according to the present application.

FIG. 2B illustrates an embodiment of oneM2M common service architecture according to the present application.

FIG. 3 illustrates an embodiment of a new Common Service Function in a router according to the present application.

FIG. 4 illustrates a network topology according to the present application.

FIG. 5 illustrates a loop-free alternate routing scheme according to the present application.

FIG. 6 illustrates an embodiment of a caching scheme according to the present application.

FIG. 7 illustrates chunk freshness of SyncCache single-path and multi-path content delivery nodes over a variable Least Recently Used (LRU) threshold.

FIG. 8 illustrates chunk freshness of SyncCache single-path and multi-path content delivery modes over variable cache sizes at a LRU threshold of 2 seconds.

### DETAILED DESCRIPTION OF THE ILLUSTRATIVE EMBODIMENTS

A detailed description of the illustrative embodiment will be discussed in reference to various figures, embodiments and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other.

This application is generally directed to efficiently using the limited caching capabilities of Cache routers (CRs) in order to maximize content distribution performance across different locations within the network. In other words, CRs collaborate among one another in order to synchronize the chunk freshness across the entire network. In particular, the introduction of more fine-grained content chunking requires in-network caching based at least in part of chunk complexity and interdependency. Complexity may be attributed to a much higher volume of items. Meanwhile, interdependency may be attributed to correlating chunks belonging to the same content object which may share a similar degree of popularity.

In this application CRs reveal their “soft” caching capability through an in-band signaling mechanism during the content resolution phase. A content chunk is the basic unit in terms of caching operations. Moreover, the caching capability of any CR in the network is determined by the freshness of the cached chunks. Freshness is defined as the time or rate at which the content is updated. Based on such information, chunk caching may more appropriately be distributed across CRs along the one or more content delivery paths in the network according to their caching load. It is further envisaged according to this application that CRs with a high chunk replacement rate may “slow down” by allocating few caching tasks to them. Meanwhile, idle CRs with low cache replacement rates may be allocated with more caching tasks.

In addition, multi-path caching is employed according to the opportunistic manner in which in-network caching is performed. Namely, more routers are capable of participating in chunk caching for each content item. To achieve this, an existing multi-path routing scheme called Loop-Free Alternates (LFA) is employed. LFA leverages one or more alternative routes between source and destination node pairs based on IP routing. As a result, the caching balancing achieved by the proposed scheme is effectively two-dimensional—both across multiple content delivery paths and across specific routers along each path. Based on this technique, flexible policies are proposed for caching management depending on specific circumstances in order to further improve the caching performance.

The following acronyms will commonly be used in this application and are therefore provided in Table 1 for reference:

TABLE 1

| ACRONYM | DESCRIPTION |
|---|---|
| AE | Application Entity |
| ADN | Application Dedicated Node |
| ACK | Acknowledgement |
| ACS | Aggregate Caching Space |
| AS | Autonomous System |
| ASN | Application Service Node |
| CCR | Cached Chunks Ratio |
| CNF | Cache-and-Forward |
| CR | Cache Request |
| CSE | Common Service Entity |
| CSR | Cache Space Ratio |
| IN | Infrastructure Node |
| ION | Information-Oriented Networking |
| IP | Internet Protocol |
| ISP | Internet Service Provider |
| LFU | Least Frequently Used |
| LRA | Loop-Free Alternate |
| LRU | Least Recently Used |
| M2M | Machine-to-Machine |
| MN | Middle Node |
| MP | Multi-Path |
| NSE | Network Service Entity |
| RR | Requesting Router |
| SP | Single-Path |
| SR | Source Router |
| TE | Traffic Engineering |

### General Architecture

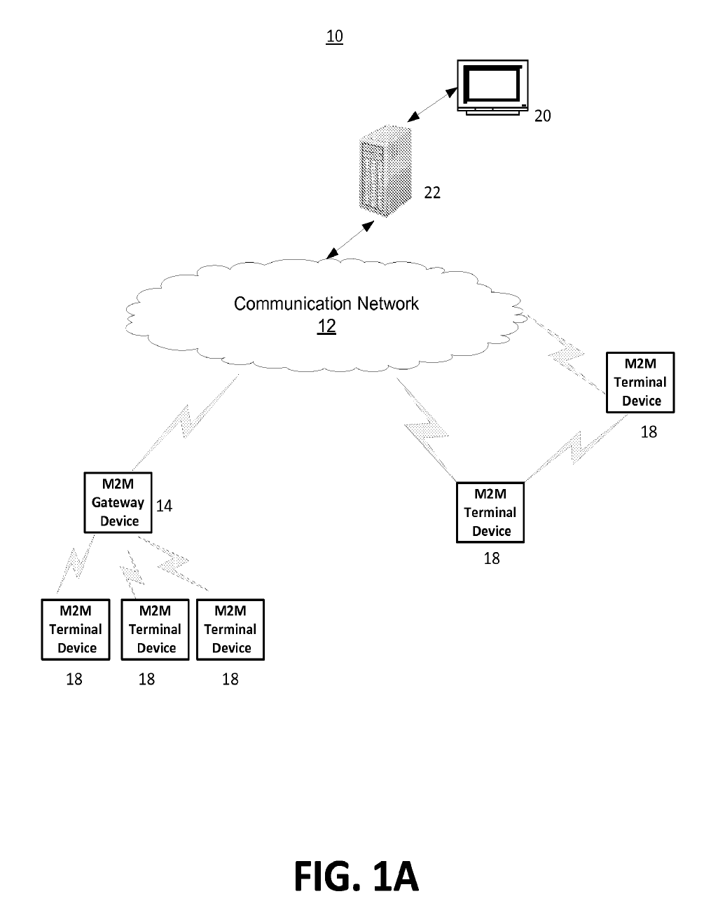

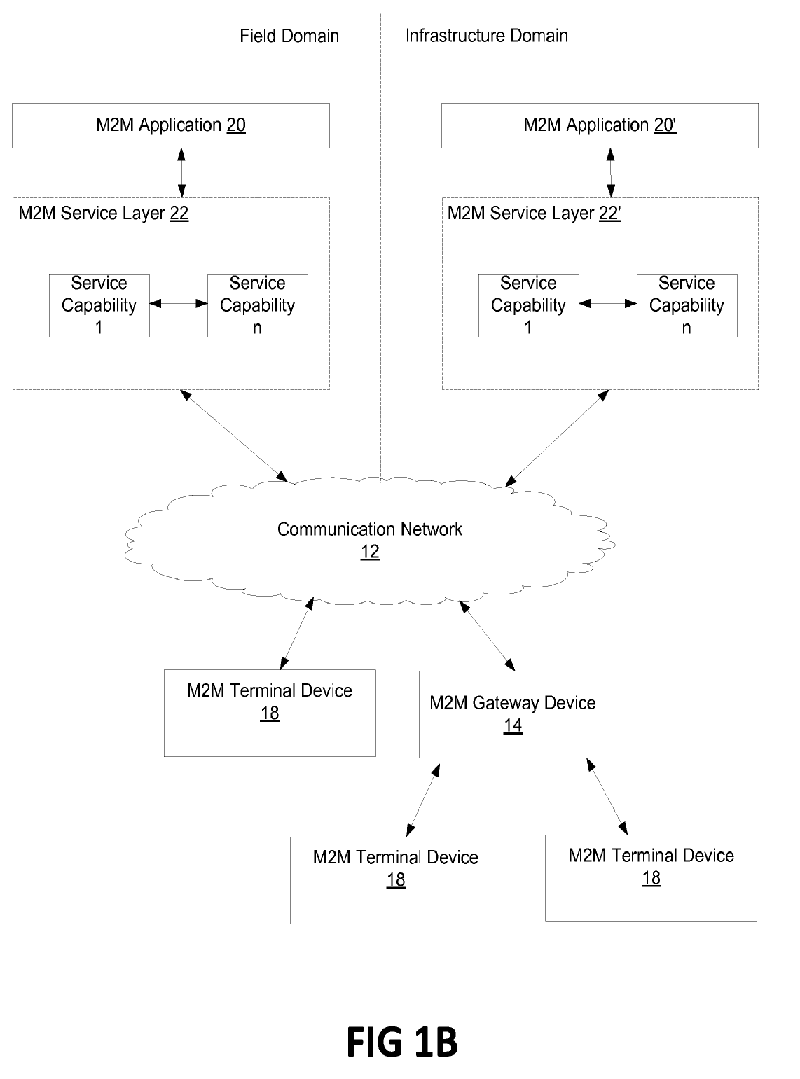

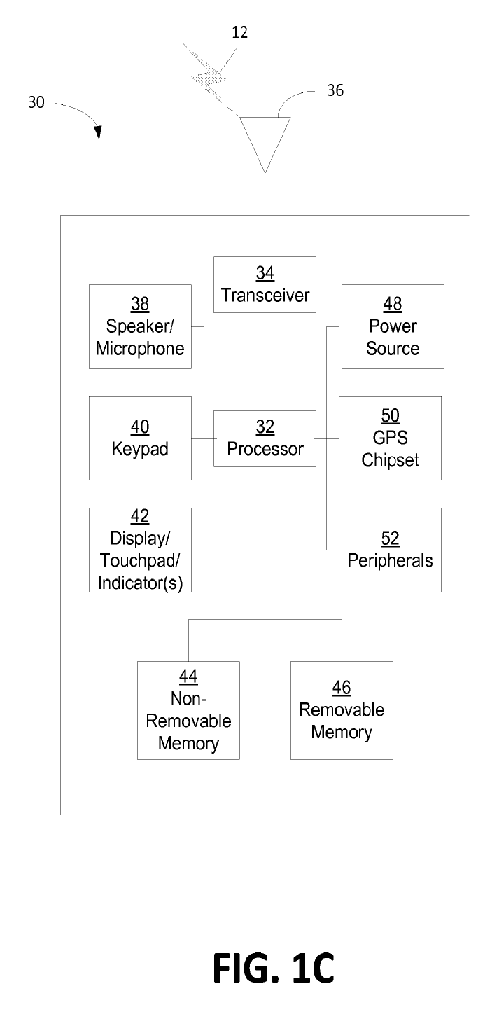

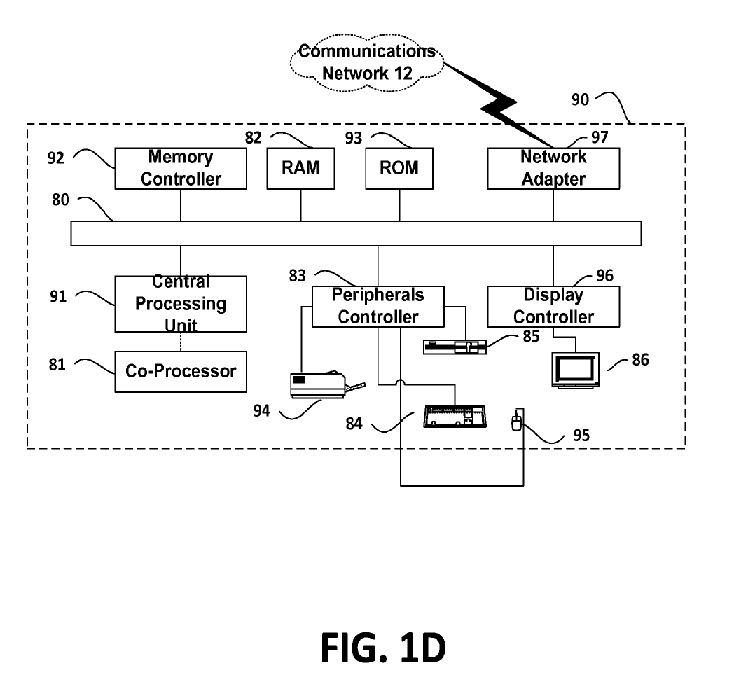

FIG. 1A is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, gateway or service platform may be a component of the IoT/WoT as well as an IoT/WoT service layer, etc.

As shown in FIG. 1A, the M2M/IoT/WoT communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. The network may include SyncCache for balancing cache loads across multiple routers along a path. Moreover, the cache loads may be balanced along routers in two or more paths, e.g., multi-path. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 1A, the M2M/IoT/WoT communication system 10 may include the Infrastructure Domain and the Field Domain. The Infrastructure Domain refers to the network side of the end-to-end M2M deployment, and the Field Domain refers to the area networks, usually behind a M2M gateway. The Field Domain includes M2M gateways 14, such as Cache routers (CRs), and terminal devices 18, such as Content clients/requestors. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals via the communication network 12 or direct radio link. The M2M gateway device 14 allows wireless M2M devices, e.g., cellular and non-cellular as well as fixed network M2M devices, e.g., PLC, to communicate either through operator networks, such as the communication network 12 or direct radio link. For example, the M2M devices 18 may collect data and send the data, via the communication network 12 or direct radio link, to a M2M application 20 or M2M devices 18. The M2M devices 18 may also receive data from the M2M application 20 or a M2M device 18. Further, data and signals may be sent to and received from the M2M application 20 via an M2M service layer 22, as described below. M2M devices 18 and gateways 14 may communicate via various networks including, cellular, WLAN, WPAN, e.g., Zigbee, 6LoWPAN, Bluetooth, direct radio link, and wireline for example. In one embodiment, the gateway device 14 may include one or more intermediate routers. The terminal devices 18 may include the requestor or a source.

Referring to FIG. 1B, the illustrated M2M service layer 22 in the field domain provides services for the M2M application 20, M2M gateway devices 14, and M2M terminal devices 18 and the communication network 12. It will be understood that the M2M service layer 22 may communicate with any number of M2M applications, M2M gateway devices 14, M2M terminal devices 18 and communication networks 12 as desired. The M2M service layer 22 may be implemented by one or more servers for sending content requested by a requester/client as discussed later in this application. The M2M service layer 22 provides service capabilities that apply to M2M terminal devices 18, M2M gateway devices 14 and M2M applications 20. The functions of the M2M service layer 22 may be implemented in a variety of ways. For example, the M2M service layer 22 could be implemented in a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateway devices 14 and M2M terminal devices 18 in the field domain. It will be understood that the M2M service layer 22′ may communicate with any number of M2M applications, M2M gateway devices such as routers, and M2M terminal devices. The M2M service layer 22′ may interact with a service layer by a different service provider. The M2M service layer 22′ may be implemented by one or more servers such as a content server, computers, virtual machines, e.g., cloud/compute/storage farms, etc., or the like.

Referring also to FIG. 1B, the M2M service layer 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layer 22 and 22′ also enables M2M applications 20 and 20′ to communicate through various networks 12 and 12′ in connection with the services that the service layer 22 and 22′ provide.

The M2M applications 20 and 20′ may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geo-fencing, device/service discovery, and legacy systems integration, and provides these functions as services to the M2M applications 20 and 20′. Moreover, the M2M service layer may also be configured to interface with other devices such as Content servers, CR and Content requesting clients as discussed in this application and as illustrated in the figures.

The method of determining how much cache space is associated with particular content for an item, such as a movie file, to be stored on a CR in a path on the network may be implemented as part of a service layer. The service layer is a software middleware layer that supports value-added service capabilities through a set of Application Programming Interfaces (APIs) and underlying networking interfaces. ETSI M2M's service layer is referred to as the Service Capability Layer (SCL). The SCL may be implemented within an M2M device (where it is referred to as a device SCL (DSCL)), a gateway (where it is referred to as a gateway SCL (GSCL)) and/or a network node (where it is referred to as a network SCL (NSCL)). The oneM2M service layer supports a set of Common Service Functions (CSFs), e.g., service capabilities. An instantiation of a set of one or more particular types of CSFs is referred to as a Common Services Entity (CSE) which can be hosted on different types of network nodes, e.g., infrastructure node, middle node, application-specific node. Further, the method of reserving a Track as described in the present application can be implemented as part of an M2M network that uses a Service Oriented Architecture (SOA) and/or a resource-oriented architecture (ROA) to access services such as the reserving a track according to the present application.

FIG. 1C is a system diagram of an example M2M device 30, such as an M2M terminal device 18 or an M2M gateway device 14 for example. As shown in FIG. 1C, the M2M device 30 may include a processor 32, a transceiver 34, a transmit/receive element 36, a speaker/microphone 38, a keypad 40, a display/touchpad/indicator(s) 42, non-removable memory 44, removable memory 46, a power source 48, a global positioning system (GPS) chipset 50, and other peripherals 52. For example, the processor for a content router may include a Content Publication Manager (CPM), Bloom filter processor, and/or a Content Resolution Manager (CRM) as will be discussed in more detail below and illustrated in the accompanying drawings. The M2M terminal device 18 may be a Content client and the M2M gateway device 14 may be a Content router or Content server according to the description of the application. It will be appreciated that the M2M device 40 may include any sub-combination of the foregoing elements while remaining consistent with an embodiment. This device may be a device that uses the disclosed systems and methods for embedded semantics naming of sensory data. The M2M device 30 may also be employed with other devices as described in this application and as illustrated in the figures.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, and/or any other functionality that enables the M2M device 30 to operate in a wireless environment. The processor 32 may be coupled to the transceiver 34, which may be coupled to the transmit/receive element 36. While FIG. 1C depicts the processor 32 and the transceiver 34 as separate components, it will be appreciated that the processor 32 and the transceiver 34 may be integrated together in an electronic package or chip. The processor 32 may perform application-layer programs, e.g., browsers, and/or radio access-layer (RAN) programs and/or communications. The processor 32 may perform security operations such as authentication, security key agreement, and/or cryptographic operations, such as at the access-layer and/or application layer for example.

The transmit/receive element 36 may be configured to transmit signals to, or receive signals from, an M2M service platform 22. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 1C as a single element, the M2M device 30 may include any number of transmit/receive elements 36. More specifically, the M2M device 30 may employ MIMO technology. Thus, in an embodiment, the M2M device 30 may include two or more transmit/receive elements 36, e.g., multiple antennas, for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable non-transitory memory, such as the non-removable memory 44 and/or the removable memory 46. The non-removable memory 44 may include random-access memory (RAM), read-only memory (ROM), a hard disk, or any other type of memory storage device. According to this application, the memory may include space available for storing content associated with a particular content request. More particularly, the memory includes space for storing content chunks associated with the content item. The removable memory 46 may include a subscriber identity module (SIM) card, a memory stick, a secure digital (SD) memory card, and the like. In other embodiments, the processor 32 may access information from, and store data in, memory that is not physically located on the M2M device 30, such as on a server or a home computer.

The processor 32 may receive power from the power source 48, and may be configured to distribute and/or control the power to the other components in the M2M device 30. The power source 48 may be any suitable device for powering the M2M device 30. For example, the power source 48 may include one or more dry cell batteries, e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information, e.g., longitude and latitude, regarding the current location of the M2M device 30. It will be appreciated that the M2M device 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1D is a block diagram of an exemplary computing system 90 on which, for example, the M2M service platform 22 of FIG. 1A and FIG. 1B may be implemented. Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Co-processor 81 is an optional processor, distinct from main CPU 91 that performs additional functions or assists CPU 91. CPU 91 and/or coprocessor 81 may receive, generate, and process data related to the disclosed systems and methods for embedded semantic naming, such as queries for sensory data with embedded semantic names.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. Display 86, may display sensory data in files or folders using embedded semantics names. Further, computing system 90 may contain network adaptor 97 that may be used to connect computing system 90 to an external communications network, such as network 12 of FIG. 1A and FIG. 1B.

### OneM2M Architecture

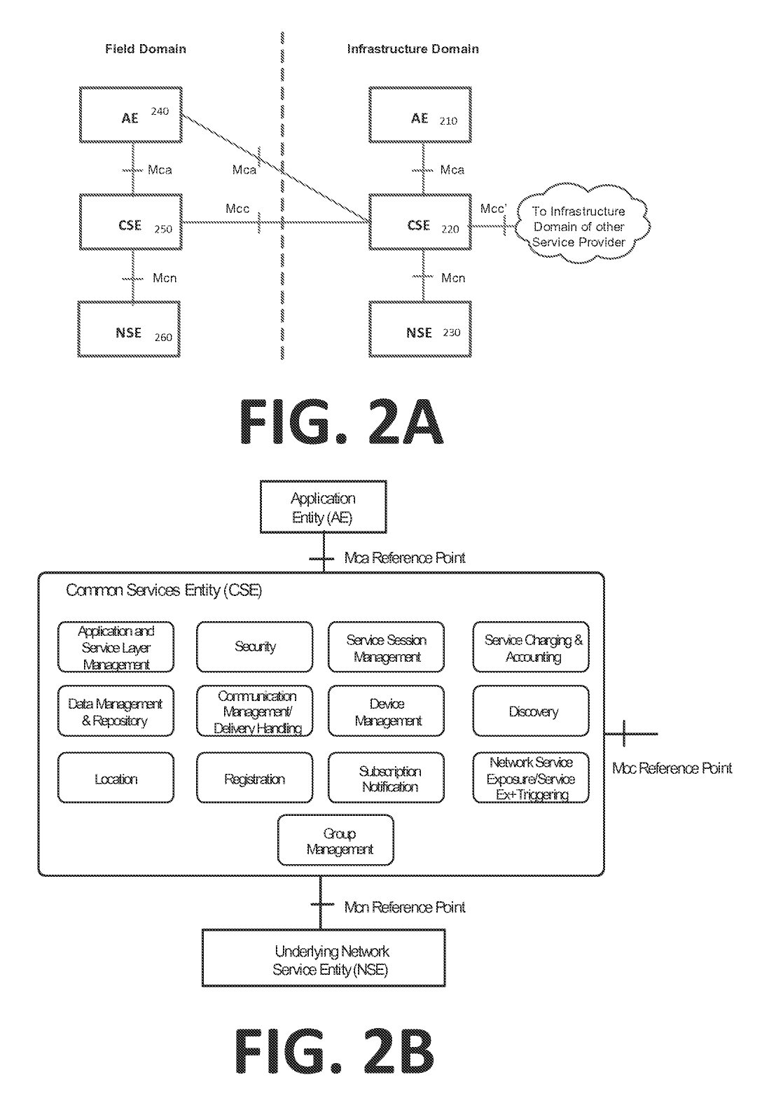

The oneM2M architecture may also include a Service Layer as shown in FIG. 2A. The goal of the Service Layer is to provide “horizontal” services that can be utilized by different ‘vertical’ M2M silo systems and applications, e.g., e-Health, fleet management, and smart homes. In particular, the Service Layer includes a Common Service Entity (CSE) 220 in a Field Domain and Infrastructure Domain as illustrated in FIG. 2A. A CSE contains multiple logical functions called “Common Service Functions (CSFs)”, such as “Discovery”, “Data Management & Repository.” The CSE supports four reference points. The Mca reference point interfaces with the Application Entity (AE) 210. The Mcc reference point interfaces with another CSE 250 within the same service provider domain and the Mcc′ reference point interfaces with another CSE in an Infrastructure Domain of another Service Provider. The Mcn reference point interfaces with the underlying network service entity (NSE) 230/260. A NSE 230/260 provides underlying network services to the CSEs 220/250, such as device management, location services and device triggering.

According to an embodiment, as illustrated in FIG. 2B, the CSF may include one or more functionalities. In particular, the CSF may reside in different Common Service Entities (CSE) such as M2M servers, M2M gateways, and M2M devices. The Content server connects to CSF in the CSE over an oneM2M Mca interface. Content resolution or discovery message as well as content may also be transmitted over Mca interface from the Content client to the CSF as well as from the CSF to the Content server over Mca interface.

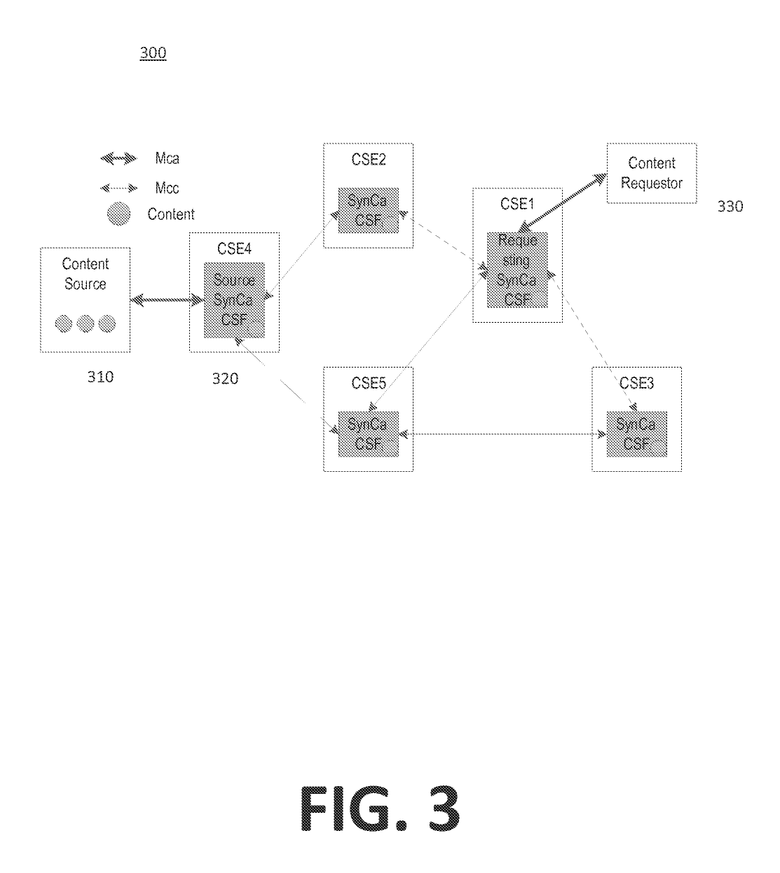

In another embodiment, FIG. 3 illustrates a system 300 with SyncCache CSFs (SynCa CSF) in CSEs for oneM2M. Each of the CSFs is shown as having content indicated by the circle. The Mca interfaces between the Content source 310 and the first-hop CSE on a CR 320, e.g., CSE4, as well as between the Content requestor 330 and its first-hop CSE, e.g., CSE1. The Mcc interfaces between CSEs. The SynCa CSF may include one or more of the following properties:

The SynCa CSF closest, i.e., with minimum hops to the Content Source is referred to as Source SynCa CSF. Source SynCa CSF has all proposed functions as discussed in this application for the Source Router.

The SynCa CSF closest, i.e., with minimum hops, to the Content Requestor is referred to as Requesting SynCa CSF. Requesting SynCa CSF has all proposed functions as discussed in this application for the Requesting Router.

Other SynCa CSFs have all proposed functions as discussed in this application for CRs.

The proposed messages for interactions between Source Router and CR will be transmitted over oneM2M Mcc interface between Source SynCa CSF and other regular SynCa CSF.

The proposed messages for interactions between CRs will be transmitted over oneM2M Mcc interface between regular SynCa CSFs.

The proposed messages for interactions between the Requesting Router and the CR will be transmitted over oneM2M Mcc interface between the Requesting SynCa CSF and other regular SynCa CSFs.

### Network Topology

According to one aspect of the present application, a network topology including multiple CRs in one or more delivery paths is described. The CRs may be located between a requestor and a source. A CR that is directly connected to a content source is referred to as Source Router (SR). The SR may be regarded as the content gateway or proxy for the Content server. A CR that is directly connected to a Content requestor may be referred to as Requesting Router (RR).

In one embodiment, a CR may cache popular content objects passing through it in order to serve any future requests for the same content. The caching decision made by each CR may take into account specific characteristics such as content popularity as well as properties and policies that enable controllable and coordinated content caching operations.

In another embodiment, requests from a requester, e.g., consumer, are based on the entire content level instead of being chunk specific. In an alternative embodiment, the request from a requester may be chunk specific.

In yet another embodiment, content items may be chunked while being distributed within the network. Alternatively, a content object, such as for example, a large movie file, may be chunked at the content source, e.g., Content server. In turn, each chunk may be delivered and/or independently cached and then reassembled at the requestor. Content chunks associated with a content item may all be the same or different sizes. For the purposes of explaining the concept of this application, the content chunks are taken to be equally sized so that the content storage space may be represented by the number of chunks which may be accommodated.

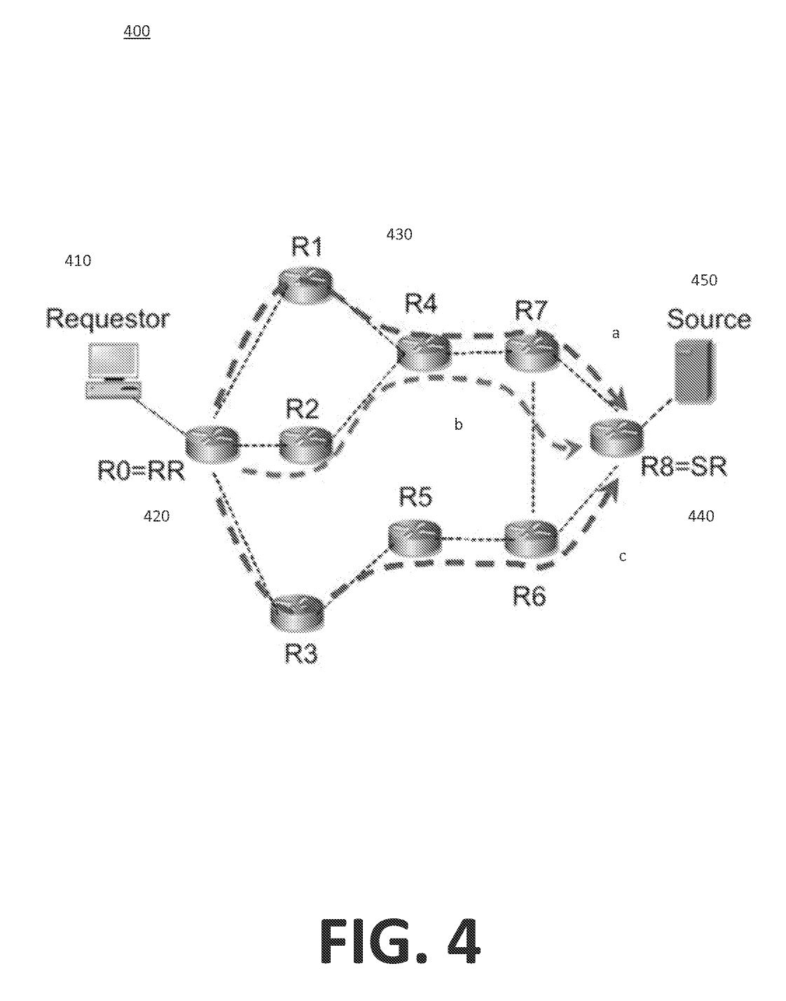

According to another embodiment as shown in FIG. 4, the concept of ‘SyncCache’ is described with respect to the network 400. Here, the RR 420 closest, or connected, to the Requester 410, determines how content chunks belonging to a content object should be cached within the network 400. During the delivery phase from the Requester 410, content chunks may be sent to individual CRs 430 located along one or more paths, e.g., a, b, or c in the network between the RR 420 and SR 440. While three paths are shown in network 400, it is envisaged that more or less paths may be available.

The caching task load across CRs 430 is distributed among them according to their “soft” caching capability. Specifically, all routers within the network are preconfigured with a unified threshold that regulates the top portions of obsolete chunks. Preferably, this is determined either by LFU and/or LRU to assess replacement. In particular, LFU is a type of cache algorithm used to manage memory within a computer. The standard characteristics of this method involve the system keeping track of the number of times a block is referenced in memory. When the cache is full and requires more room the system will purge the item with the lowest reference frequency. On the other hand, LRU discards the least recently used items first. This algorithm requires keeping track of what was used when, Moreover, general implementations of this technique require keeping “age bits” for cache-lines and track the LRU cache-line based on age-bits. In such an implementation, every time a cache-line is used, the age of all other cache-lines changes.

In one example, based on LRU, all cached chunks not being requested within a preconfigured time period may be treated as obsolete. The time period may be controlled by the network operator. As such, the corresponding caching space for these chunks can be deemed as “soft” caching capability. This means that it is considered part of the LCS of a router that is sent to a Content source. Moreover, each of the CRs 430 may have different free caching space for accommodating future incoming chunks depending upon their specific location in a path, e.g., a, b, or c, located in the network 400. As described in further detail below, LCS is the stored memory reserved on a single router. Meanwhile, ACS is the sum of one or more router's LCS.

According to another embodiment, when a CR 430 forwards a content request originating from the Requestor 410, it declares its own soft caching space information which will be carried in the request message hop-by-hop towards the Content source 450. The free caching space declared by each CR 430 along the entire request forwarding path are added up by the time it reaches the Content source 450. Moreover, pending content delivery states are installed in the non-transitory memory of the CRs 430 located along the path during the requesting phase. This helps maintain the actual content delivery paths in the reverse direction.

Next, the SR 440 returns back an acknowledgement message to the Requester 410 following the reversed path in which the content request originated. The acknowledgment message carries information on the overall free caching space along the path. Accordingly, each CR 430 that receives the message is able to determine its own proportional caching load for the new content according to its originally declared “soft” caching space.

Subsequently, content chunks begin to be transmitted from the Source 450 through the SR 440. Each of the CRs 430 in the path will cache a subset of the transmitted content chunks. Preferably, the CRs will proportionally cache a subset of the transmitted content chunks according to its previously declared free space against the total space along that delivery path.

According to another embodiment, SyncCache may also be built on top of multi-path routing schemes in order to allow more CRs 430 to share the optimized caching load. In other words, a two-dimensional caching load model may be employed wherein cache load is shared among both multiple paths and individual routers belonging to the same path. As illustrated in FIG. 4, the caching load may be shared by paths a, b and c located between RR 420 and the SR 440. The caching load may also be proportionally shared by the CRs 430 within each path according to their declared free space. For example, path a includes CRs R1, R4 and R7 between RR 420 and SR 440. Path b includes CRs R2, R4, R7 and R8 between RR 420 and SR 440. Path c includes CRs R3, R5 and R6 between RR 420 and SR 440. Here, the cache load of a specific CR may be based upon the shared cache load, equal or not, of each path in the network in addition to the declared cache space for each specific CR.

Moreover, LFA is a technique that may be employed in the present application in order to cache content chunks which may be coordinated among routers belonging to different paths. (See A Survey of Information-Centric Networking, B. Ahlgren, IEEE Communications Magazine 50 (7), 2012, pp. 26-36.) In particular, LFA indicates that an original router can “deflect” a packet onto a neighboring router. The neighboring router may not be located on the shortest path to the Requester 410. Regardless, the neighboring router is not permitted to return the packet back to original router that deflected the packet.

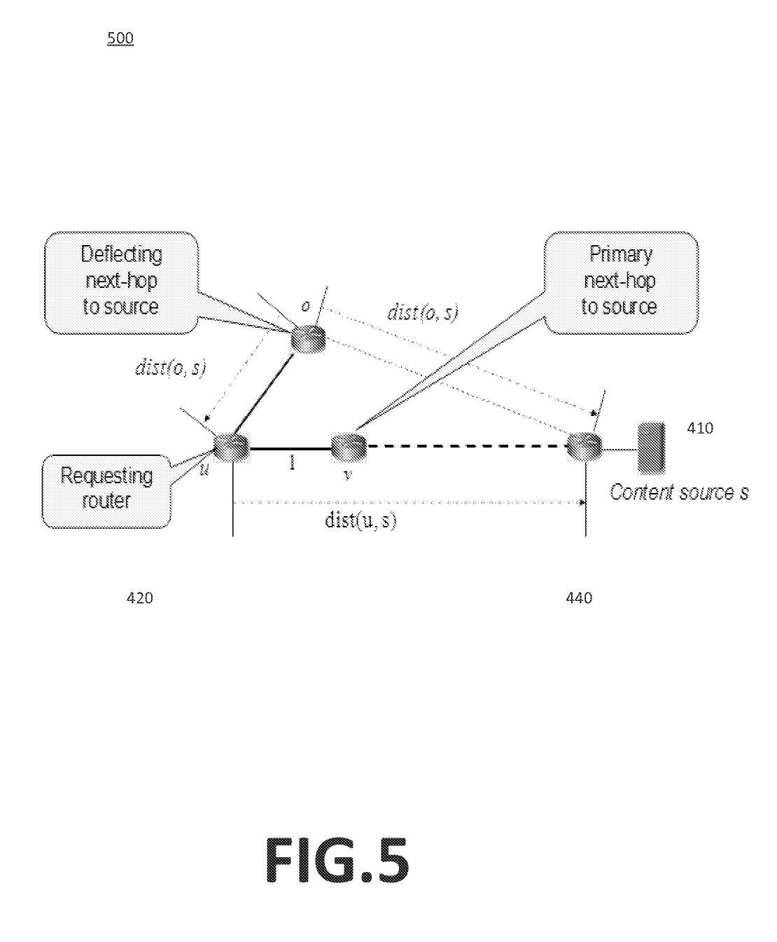

According to another embodiment, when LFA is applied for enabling multi-path SyncCache, the RR 420 simultaneously sends request messages to the default shortest path as well as all other feasible paths according to LFA. FIG. 5 provides an exemplary illustration of a feasible path 500 according to LFA. Here, the path 500 may be identified according to the following equation below:

dist(o,u)+dist(u,s)>dist(o,s), (1)

where u is the RR 420, s is the SR 440, o is a neighboring router of u, and dist(x,y) is the distance between the routers x and y. If the above condition holds, then o is selected by u as a feasible next-hop router to send a copy of content request towards s. In this case, the RR or u 420 forwards the content request to all the feasible LFA neighbors towards the SR 440. When SR 440 receives content requests for the same content object via different LFA paths from the RR, SR 440 will send dedicated acknowledgement messages back via each LFA path. In this case, each LFA path carries the sum of caching capability along that path.

### Content Requesting

According to another embodiment, the techniques of SyncCache in the context of LFA-based multi-paths routing is described in further detail. Upon receiving a request from the locally attached Requester 410, the RR 420 sends copies of the content request message towards the Source 450 via the default path and additional LFA paths. Each request message includes one or more of the following kinds of data:

Requested content identifier (ID)

ID, e.g., IP address, of the Requester 410

Caching request indicator

Path identifier

ACS of the path

The ID of the Requester 410 in each request message is used to indicate to the SR 440 that these content requests from different incoming paths are effectively originated from one single requester but from different paths. It is envisaged that the SR 400 acts as a gateway for the content source. The ID is used to differentiate from instance in which multiple clients simultaneously request the same content via specific paths.

The caching request indicator informs CRs in the delivery paths that the content chunks belonging to this content need to be cached. As such, these intermediate CRs need to declare their LCS for caching them while forwarding the request towards the Content sSource 450. The path identifier is determined by the RR 420, so that when the Content Source 450 has received copies of the request message for a content object, it knows the sum of aggregated caching space associated with each path ID.

The RR 420 is configured to evenly split its own LCS in terms of the number of chunks which may be replaced and set this to be the current ACS of each path. The ACS is the sum. When an intermediate in-path CR 430 receives a request, it installs the content state, which includes the content ID and the address/interface of the previous-hop router from where the request was received in its memory. The content state will be used when forwarding content chunks towards the Requestor 410. In one embodiment, if no state has previously been installed for this content ID, the CR 430 determines its own LCS and then updates the value of the ACS along the path which is carried in the content request. This is achieved by adding its own LCS to the current ACS value.

Further an intermediate router may determine its LCS in instances where it has not yet reached its physical storage capacity limit. In this case, the intermediate router will declare its actual free space in terms of number of content chunks.

On the other hand, if intermediate router's storage limit has been reached, then each subsequent router will need to compute the LCS value based on the “preconfigured threshold” by the network operator that is unified across all routers. If the LRU policy is applied, for example, the threshold may be set by identifying all locally cached content chunks that have not been visited for a pre-determined period of time. The caching space used for these identified, obsolete, cached content chunks may then be used for caching future incoming chunks. The total number of these chunks is considered the value of LCS declared by the specific router.

When the SR 440 receives the request from path i, it knows the final ACS of that path:

$$ACS ( Path i ) = r {0}_{i} + {\sum }_{k = 1}^{{n}_{i}} {r}_{i , k} , \qquad ( 2 )$$

whereby r0ᵢ is the LCS at the RR for path i, and r_{i,k} is the LCS of an intermediate router k located in path i. The value of nᵢ indicates the total number of routers along path i which should share the caching load.

An intermediate router shared by multiple parallel paths may receive more than one copy of the content request for a particular content ID. For example, R4 in FIG. 4 may receive more than one copy of the content request because it belongs to paths a and b. In this case, the router will update the ACS value of the first request for that content ID and disregard the second and further requests.

### Sending Acknowledgements and Content Chunks

According to yet another embodiment, when the SR 440 receives the content request message for a path i, it will send back an Acknowledgement (ACK) along the reversed paths based on the pending content states. This message will carry the final ACS for this path. Based on this, each router along that path will determine its local CSR. The CSR of the router k for path i is:

$${CSR}_{i , k} = \frac{{r}_{i , k}}{ACS ( path i )} , \qquad ( 3 )$$

In the multi-paths scenario, the SR 440 determines the content chunk splitting ratio across these paths according to the final ACS values received from each of these paths. Then, the content chunks are split by the SR 440 and forwarded via the return paths maintained by their local content states. In one embodiment, the SR 440 forwards the number of chunks onto these paths in a Weighted Round Robin (WRR) manner proportional to the ACS value of each path. Routers along the same return path coordinate with each other according to their own CSR for caching the correct portion of content chunks in a complementary way.

### A Windows-Based Caching Algorithm

According to yet another embodiment, a windows-based caching algorithm is disclosed. Each router in the network may include an algorithm in its memory that is executed by a processor operably connected to the memory. In this embodiment, the caching decision is made along. In particular, a router with a CSR value being X %, is responsible to approximately transform “X %” into the closest “t₁ out of t₂”, with a maximum allowable value of t₂ that represents the caching window size. For example, if t₂=10(chunks), then 20% is 2/10 chunks, 33% is 3/10 chunks (with approximation), and 72% is 7/10 (with approximation).

The algorithm provided below, e.g., Algorithm 1, presents the caching algorithm within each window having a window size=t₂. In particular, the router that caches a chunk will mark it. By so doing, the marked chunk will not be cached by a downstream router. In some instances, the higher window size, e.g., value of t₂, results in a higher probability that consecutive chunks are cached at the same router.

Algorithm 1 Window-based caching algorithm

| | |
|---|---|
| 1: | counter1 = 0; |
| 2: | counter2 = 0; |

| | |
|---|---|
| 3: | While (incoming chunk not finished) & (counter2 < t2) |

| | |
|---|---|
| 4: | counter2++; |
| 5: | If (incoming chunk unmarked) & (counter1 < t1) then |

| | |
|---|---|
| 6: | Cache the chunk and mark it CACHED; |
| 7: | Forward the chunk to its next hop toward RR; |
| 8: | counter1++; |

| | |
|---|---|
| 9: | Handle the next Incoming content chunk |

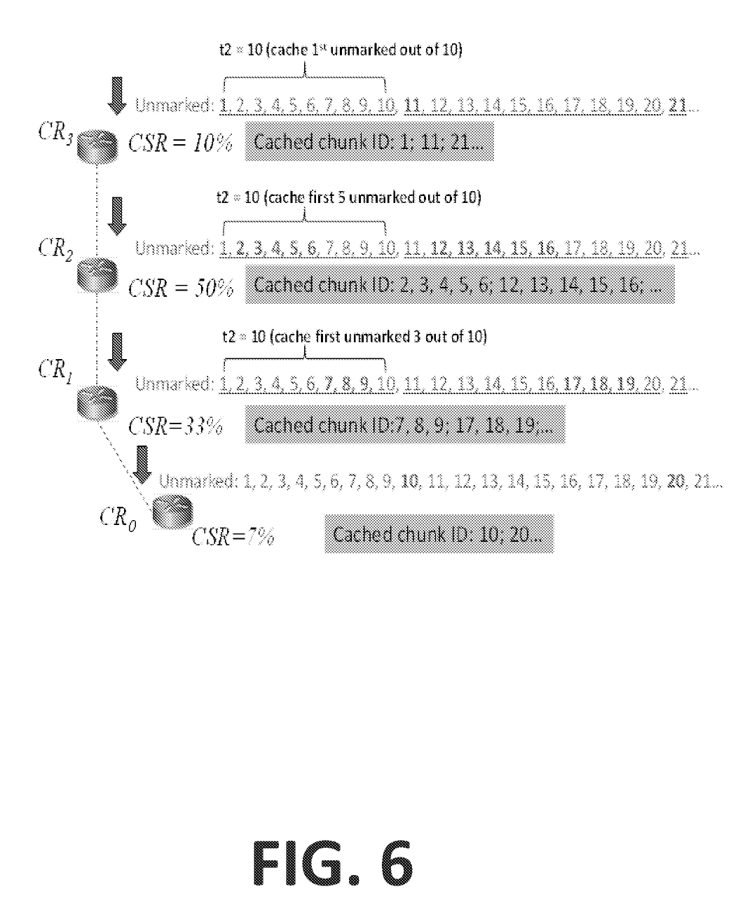

In a multi-path scenario, since the SR 440 forwards the content chunks onto multiple paths using WRR, the content chunks forwarded onto each path will not have a consecutive ID sequence. In other words, the window-based caching mechanism along each path is effectively based on the actual number of content chunks being counted by each router instead of the real chunk ID. For simplicity, however, consecutive chunk IDs are used below in the embodiment shown in FIG. 6. Here, it is assumed that the CSRs of involved routers for that single path are 10%, 50% and 33%, respectively. The remaining 7% of the content chunks will be cached at the RR which is CR₀. The window size of the routers is set to 10 content chunks for ease of calculation. The application is envisaged to have as many chunks as necessary for the content object. When considering the first 21 content chunks belonging to the same content object passing through this path, the first content router CR₃, e.g., the one nearest the source, has a CSR of 10% and a window size t₂=10, t₂=10. Hence t₁=1. This router receives all content chunks unmarked. It will cache, and mark as cached, the first chunk out of every 10 chunks in each window. Here, the cached content chunks will be 1, 11, and 21 for each of the windows respectively. It also marks these content chunks as cached.

The second downstream content router CR₂, based on its CSR (50%) and window size (t₂=10), will cache the first 5 unmarked chunks out of 10 content chunks in the window, based on t₁=5. Since chunk 1 in the window has already been cached, this router will cache content chunks 2, 3, 4, 5 and 6. CR₂ will also cache content chunks 12, 13, 14, 15 and 16.

Similarly, the third router CR₁ (CSR=33%) will cache the first 3 unmarked content chunks out of 10 based on approximated t₁=3. As such, it will cache the first 3 unmarked content chunks within each window, namely content chunks 7, 8 and 9 in the first window, and content chunks 17, 18 and 19 in the second window, etc.

Further, all unmarked content chunks, e.g., content chunks 10 and 20, will be cached at the RR. As shown in FIG. 6, CR₀ will be allocated 7% CSR. According to this application, with different settings of t₂, the actual content chunks cached at individual content routers can be very different. However, it is understood that the actual caching load among the involved routers is still approximately proportional to their CSR.

### Results and Experiments

The results below provide examples of the above-mentioned embodiments according to the present application. The performance of the SyncCache was evaluated by computer simulation with NS-3 network simulator (See http://www.nsnam.org, October 2013.) Specifically, the Chunk Freshness Ratio (CFR) was assessed via the simulation.

The CFR is defined as the ratio of the minimum of “the oldest content chunk lifetime” among all routers over the maximum of “the oldest content chunk lifetime” among all routers. In other words, this metric indicates the relative life-time gap between the busiest router and the most idle router with regard to their “oldest” content chunks in their cache. The CFR takes on values between 0 and 1. The closer the CFR is to 1, the more optimal it is for the network/path to achieve freshness balancing.

The following simulation assumptions are taken for running simulations. The network topology is a GEANT consisting of 23 nodes. 5 of these nodes are source nodes. These source nodes are randomly chosen. There are 200 content files in the network and each file consists of 50 content chunks. As such, there are 10,000 total content chunks.

Moreover, the content popularity follows a Zipf distribution with exponent 0.73. The files are uniformly distributed across the 5 source nodes. 1,000 content requests for the content files are generated. These requests are uniformly distributed across all 23 nodes and are based on the popularity of each file.

Each node is equipped with a cache. Cache size starts with 10 content chunks and increases by 10 up to 100. Accordingly, the total caching space varies from 2.3% to 23% of the total content population. The considered replacement policy is LRU with a replacement threshold of 1 to 8 seconds. The cached content chunks lifetimes are on the order of a few seconds. The window size is 10 chunks. The presented results are mean values from 5 runs.

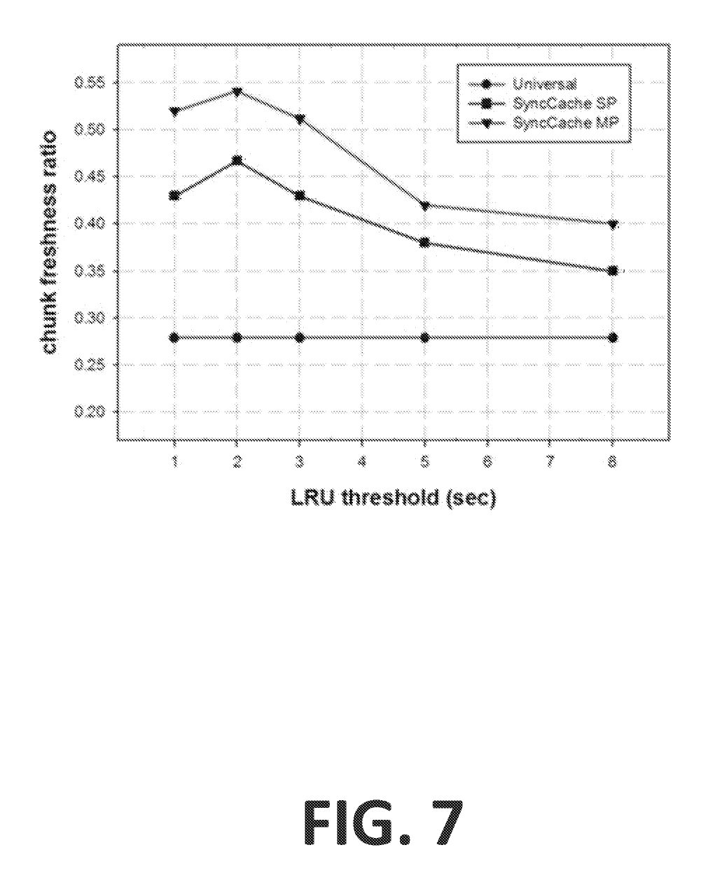

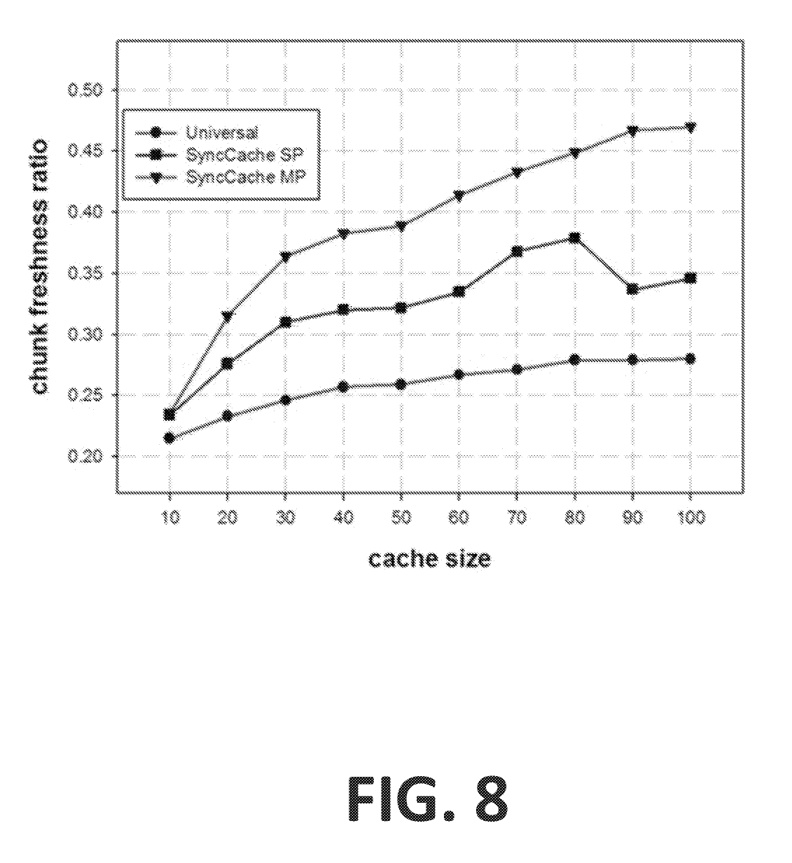

As provided in FIGS. 7 and 8, the SyncCache for multi-path (MP) and single-path (SP) content delivery modes is evaluated and compared with the Universal caching scheme. Namely, FIG. 7 shows the resultant CFR for various LRU replacement thresholds. The cache sizes are fixed to 80 content chunks. As observed for all cases, the freshness ratio achieved by SyncCache (both MP and SP) is significantly higher than that of the Universal caching scheme. Moreover, the largest gap is 0.55 for the MP case compared to 0.28 in the Universal caching case. Notably the Universal caching scheme does not have the concept of LRU/LFU threshold. Instead the least recently/frequently visited content chunk is to be replaced. As such its performance is orthogonal to the LRU threshold in FIG. 7.

Moreover, for low values of the LRU replacement threshold, the content CFR has almost doubled. It is observed that the MP scheme slightly outperforms the SP scheme. The setting of the LRU threshold can also substantially influence the content CFR performance. As shown with a caching space of 80 chunks, the setting of 2 seconds for LRU threshold produces the highest chunk freshness ratio.

As shown in FIG. 8, the LRU replacement threshold is fixed at 2 seconds. The resultant CFR for various cache sizes is provided along the Y-axis. Similar to FIG. 7, it is also observed that the SyncCache achieves a significantly higher content CFR compared to the Universal caching. Also, the MP mode outperforms the SP mode for all cache sizes. The delay reduction ratio for these two scenarios is also investigated. Further, in the case of the SP delivery, the delay is reduced to 40-50%. Meanwhile, in the MP delivery, the reduction is 35-40% of the original delay.

According to yet another aspect of the present application, it is understood that any or all of the systems, methods and processes described herein may be embodied in the form of computer executable instructions, e.g., program code, stored on a computer-readable storage medium which instructions, when executed by a machine, such as a computer, server, router, or the like, perform and/or implement the systems, methods and processes described herein. Specifically, any of the steps, operations or functions described above may be implemented in the form of such computer executable instructions. Computer readable storage media include volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other physical medium which can be used to store the desired information and which can be accessed by a computer.

According to yet another aspect of the application, a non-transitory computer-readable or executable storage medium for storing computer-readable or executable instructions is disclosed. The medium may include one or more computer-executable instructions such as disclosed above in the call flows such as in FIGS. 3-6. The computer executable instructions may be stored in a memory and executed by a processor disclosed above in FIGS. 1C and 1D, and employed in devices including but not limited to routers, requesters or sources. In one embodiment, a computer-implemented router having a non-transitory memory and processor operably coupled thereto, as described above in FIGS. 1C and 1D, is disclosed. Specifically, the non-transitory memory of the router has instructions stored in a Local Cache Space (LCS) for saving content chunks for requested content. The processor is configured to perform the instructions of: (i) receiving a content request from a requester along a path in a network; determining its Local Cache Space (LCS); (iii) calculating current Aggregated Caching Space (ACS) along the path; (iv) sending LCS and current ACS information along the path to a source; and (v) receiving final ACS information along the path from the source.

While the systems and methods have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. A networked router comprising:
a non-transitory memory including local cache space for saving content chunks for requested content; and
a processor operably coupled to the memory, the processor configured to execute the instructions of:
receiving a content request from a requester along a path in a network;
determining the local cache space;
calculating current aggregated caching space along the path;
sending the local cache space and current aggregated caching space information along the path to a source; and
receiving final aggregated caching space information along the path from the source.

2. The router of claim 1, wherein the processor further executes the instructions of:
determining a caching space ratio for the content request based upon the local cache space information and the final aggregated caching space information.

3. The router of claim 1, wherein the memory further includes a synch cache common service function.

4. The router of claim 1, wherein the process further executes the instructions of:
receiving content chunks based upon the content request from the source; and
caching a subset of the received content chunks according to the caching space ratio along the path.

5. The router of claim 1, wherein
the content request is received along two paths in the network; and
the local cache space and the current aggregated cache space information is sent along the two paths in the network.

6. The router of claim 5, wherein the current aggregated cache space information is received along each of the two paths.

7. The router of claim 1, wherein the content request includes data selected from a requested content id, id of the content requester, caching request indicator, path identifier, aggregated cache space of the path, and combinations thereof.

8. The router of claim 1, wherein the sent local caching space information indicates space available for content chunks of the requested content.

9. The router of claim 1, wherein the local caching space information indicates locally cached content chunks that are idle for a pre-determined period.

10. The router of claim 1, further comprising:
a chunk freshness ratio, at a fixed least recently used threshold of 2 seconds over a cache size less than or equal to 100, greater than y=6.6*10⁻⁴x+0.15.

11. A method for caching content at a router comprising:
receiving a content request from a requester along a path in a network;
determining local cache space;
calculating current aggregated caching space along the path;
sending the local cache space and the current aggregated caching space information along the path to a source;
receiving final aggregated cache space information along the path from the source; and
determining a caching space ratio for the content request based upon the local cache space and the final aggregated caching space information.

12. The method of claim 11, further comprising:
receiving content chunks based upon the content request from the source; and
caching a subset of the received content chunks according to the caching space ratio along the path.

13. The method of claim 12, wherein
the content request is received along two paths in the network; and
the local cache space and current aggregated cache space information is sent along the two paths in the network.

14. The method of claim 12, wherein the current aggregated cache space information is received along each of the two paths.

15. The method of claim 12, wherein the content request includes data selected from a requested content id, id of the content requester, caching request indicator, path identifier, aggregated cache space of the path, and combinations thereof.

16. The method of claim 12, wherein the sent local cache space information indicates space available for content chunks of the requested content.

17. The method of claim 12, wherein the local cache space information indicates locally cached content chunks that are idle for a pre-determined period.

18. The method of claim 12, wherein a chunk freshness ratio of the router is greater than 0.3 at a least recently used threshold of 1 to 8 seconds employing 23 nodes, with 5 of the nodes being source nodes.

19. The method of claim 18, wherein the chunk freshness ratio is greater than 0.4.

20. The method of claim 12, wherein a chunk freshness ratio of the router at a fixed least recently used threshold of 2 seconds over a cache size less than or equal to 100 is greater than y=6.6*10⁻⁴x+0.15.
